(19) United States
(12) Patent Application Publication
(10) Pub. No.: US 2006/0188624 A1
(43) Pub. Date: Aug. 24, 2006

(54) Processed foods containing fungi for cooking by heating with a microwave oven

(75) Inventors: Seiji Yahara, Osaka (JP); Kazunori Sonobe, Osaka (JP); Taro Ishimoto, Osaka (JP); Shingo Amino, Osaka (JP)

Correspondence Address: MARSHALL, GERSTEIN & BORUN LLP, 233 S. WACKER DRIVE, SUITE 6300, SEARS TOWER, CHICAGO, IL, 60606, US

(73) Assignee: HOUSE FOODS CORPORATION, Osaka (JP)

(21) Appl. No.: 11/350,485

(22) Filed: Feb. 9, 2006

(30) Foreign Application Priority Data
Feb. 18, 2005 (JP) 2005-042777

(51) Int. Cl. A23L 3/16

(52) U.S. Cl. 426/521

(57) ABSTRACT

The present invention provides a processed food for cooking by heating with a microwave oven, containing edible fungi which do not make the sound of burst at the time of cooking by heating with the microwave oven due to treatments after harvesting them, and a processed food for cooking by heating with a microwave oven, containing edible fungi wherein the water absorption ratio of parts corresponding to those that are lightly stained in the caramel staining test is 15 weight % or more.

### TECHNICAL FIELD OF THE INVENTION

The present invention relates to processed foods for heating and cooking with a microwave oven, containing fungi which do not easily burst at the time of cooking by heating with a microwave oven, and particularly it relates to retort foods for heating and cooking with a microwave oven.

### BACKGROUND OF THE INVENTION

The problems have been pointed out that, when a food containing fungi in a retort container is heated and cooked with a microwave oven, the fungi sometimes burst during heating and the content spills out, or the container tumbles. At present, fungi used in retort foods, especially mushrooms and the like are generally boiled in water after harvesting, and then provided as ingredients of the retort foods and the like.

In order to solve the above problems, it can be thought to develop a product form at the time of cooking with a microwave oven, such as the form wherein the content does not spatter in the microwave oven even if the fungi burst. However, such deployment was technologically difficult.

Therefore, it has been desired to develop fungi themselves that do not easily burst at the time of cooking by heating with a microwave oven. However, the technology satisfying such demand has not yet been developed

### DISCLOSURE OF THE INVENTION

The object of the present invention is to provide a processed food for cooking by heating with a microwave oven, containing fungi which do not easily burst at the time of cooking by heating with the microwave oven.

The further object of the present invention is to provide a method for producing the processed food for cooking by heating with a microwave oven.

The present invention has been completed based on the finding that the above problems can be solved by giving certain treatments to harvested edible fungi.

Namely, the present invention provides a processed food for cooking by heating with a microwave oven, containing edible fungi which do not make the sound of burst at the time of cooking by heating with the microwave oven due to treatments after harvesting them.

The present invention also provides the processed food for cooking by heating with a microwave oven, containing edible fungi wherein the water absorption ratio of parts corresponding to those that are lightly stained in the caramel staining test is 15 weight % or more.

The present invention further provides a method for producing the processed food for cooking by heating with a microwave oven, which comprises steps of blanching fungi, if necessary, after harvesting them; and then freezing the fungi to use them as ingredients.

### BRIEF DESCRIPTION OF THE DRAWINGS

FIG. 1 shows the results (photograph) of the caramel staining test of the conventional products (boiled in water) and those of the present invention on mushrooms.

FIG. 2 shows the results (photograph) of the caramel staining test of the conventional products (boiled in water) and those of the present invention on Eringi mushrooms.

FIG. 3 shows the results (photograph) of the caramel staining test of the conventional products (boiled in water) and those of the present invention on Hiratake mushrooms.

FIG. 4 shows the enlarged view of the conventional products (boiled in water) in FIG. 3.

### BEST MODE FOR CARRYING OUT THE INVENTION

Edible fungi which are of the present invention include mushrooms, Eringi mushrooms, Shimeji mushrooms, and Hiratake mushrooms. Among them, mushrooms, Eringi mushrooms, Shimeji mushrooms, and Hiratake mushrooms are preferable. The fungi are particularly preferable such as those of which stems are mainly eaten.

In the present invention, those fungi can be used directly after harvesting them, or they may be cut into desired shapes to be used.

In the present invention, the above-mentioned fungi are treated. The treating methods include a step of freezing (refrigeration), preferably freezing the fungi at −10° C. or lower. In addition, it is also preferable to conduct drying, preferably freeze-drying, or sticking (including the treatment of a tenderizer). In this connection, any treatment may be conducted as long as the fungi after the treatment do not make the sound of burst at the time of cooking by heating with the microwave oven. In the present invention, “making no sound of burst at the time of cooking by heating with the microwave oven” means that the sound of burst of the fungi is not detected when the product is heated for 2 minutes by a 500 W microwave oven.

Further, the treating condition can be employed in the present invention, wherein the water absorption ratio of parts that are lightly stained in the caramel staining test is 15 weight % or more. In the present invention, the caramel staining test can be conducted according to the following process.

Caramel Staining

0.5 (kgf/cm²) of pressure is applied for 15 seconds to fungi which are picked up from the processed food and washed with water, if necessary. Next, the fungi are immersed in 2% aqueous solution of Caramel LF141 (Ikeda Tohka Industries Co., Ltd.) for 15 minutes. Then, the fungi are taken therefrom and lightly stained parts thereof are visually determined.

Method for Preparing Samples

As for the lightly stained parts determined by the above method, big fungi are cut into cubes of 10×10×5 mm. On the other hand, small (thin) ones are cut into the thickness of 5 mm and formed so that the weight thereof becomes 0.59 g. Separately from the above, the caramel staining may be conducted to the products boiled in water, and then the samples may be cut and formed, as lightly stained parts, as mentioned above from the parts of the present invention corresponding to those that are not stained in the products boiled in water.

Determination of Water Absorption Ratio

The samples for the determination (the above cut fungi) are immersed in water once for 15 seconds, drained and then their weights are determined (WO). Next, after lightly wrapping them with kimwipes, 0.5 (kgf/cm²) of pressure is applied for 15 seconds to the samples and then their weights are determined (W1). Further, the samples are immersed in water for 15 seconds, drained and their weights are determined (W2). The water absorption ratio is calculated from the values thus obtained according to the following formula.
Water absorption ratio=100×(W2−W1)/WO

In the present invention, it is preferable that the fungi are blanched to deactivate enzymes before the treatments such as the freeze. As for the treating condition of blanching, it is preferable to immerse the fungi in hot water of 70 to 100° C. for 1 to 10 minutes, and it is particularly preferable to immerse them in hot water of 80° C. for 5 minutes.

The edible fungi are blanched after harvesting them, frozen, and then thawed, if necessary, to be used as ingredients of the processed food.

In the present invention, it is preferable that the water absorption ratio of parts that are lightly stained in the caramel staining test is 20 weight % or more. It is particularly preferable that the ratio is 30 to 60 weight %.

The present invention provides processed foods for cooking by heating with a microwave oven such as retort foods, chilled foods, prepared foods, and foods filled under sterilization, containing the above fungi. The processed foods for cooking by heating with the microwave oven are the foods for cooking by heating with the microwave oven and preferably foods distributed at refrigerated or normal temperature.

Besides, the processed foods of the present invention preferably contain meats such as beef, onions and the like in addition to the fungi. For example, it is preferable to contain 1 weight % or more of starchy ingredients and more preferably 1 to 4 weight % thereof; and 70 to 90 weight % of water. Further, it is preferable to contain sauce, and it is particularly preferable that 50 to 95 weight % of sauce containing 2 to 20 weight % of oil is contained in the processed food. Meanwhile, the amount of the fungi in the processed food can be optional, and 5 to 20 weight % thereof is preferable.

In case of a retort food(s), it can be produced, for example, by filling the ingredients and sauce together with the above fungi into a retort container such as a retort pouch; and retort-sterilizing them according to the ordinary method. In this connection, as for the condition of the retort-sterilizing, it is preferably heated at about 110 to 135° C. for 5 to 130 minutes. The other forms of the processed foods are preferably produced according to the ordinary methods.

According to the present invention, fungi can be provided which do not easily burst at the time of cooking by heating with a microwave oven. Therefore, when cooling a processed food(s) such as a retort food(s) containing the fungi by heating with the microwave oven, the retort food can be prevented from spattering out because of the burst of the fungi, even if the food is put into a dish from the retort container to be heated and cooked with the microwave oven. Besides, there is an advantage that it is possible to cook the food by heating with the microwave oven under the condition that the food is in the retort container. Further, when using the fungi, there is also an advantage that there is no need of developing a special kind of retort containers or containers for using in the microwave oven. In addition, the present invention also has an advantage that original flavors of fungi are kept without destroying them since the fungi do not need to be boiled in water as conventional ones do.

Next, Examples will further illustrate the present invention. The following Example(s) only explains the present invention and does not particularly limit the invention.

### EXAMPLE 1

The harvested fungi (mushrooms, Eringi mushrooms, or Hiratake mushrooms) were boiled in water or refrigerated as follows.

Boiling in water: The fungi was blanched at 80° C. for 5 minutes and boiled in water by being heated with water at 122° C. for 30 minutes.

Refrigeration: The fungi was blanched at 80° C. for 5 minutes, frozen at −40° C., and then naturally thawed.

50 g of the fungi obtained by the above methods were filled together with 150 g of curry sauce into a retort pouch and retort-sterilized at 122° C. for 23 minutes.

The fungi were taken from the pouch, and the caramel staining was conducted to them in accordance with the above procedure.

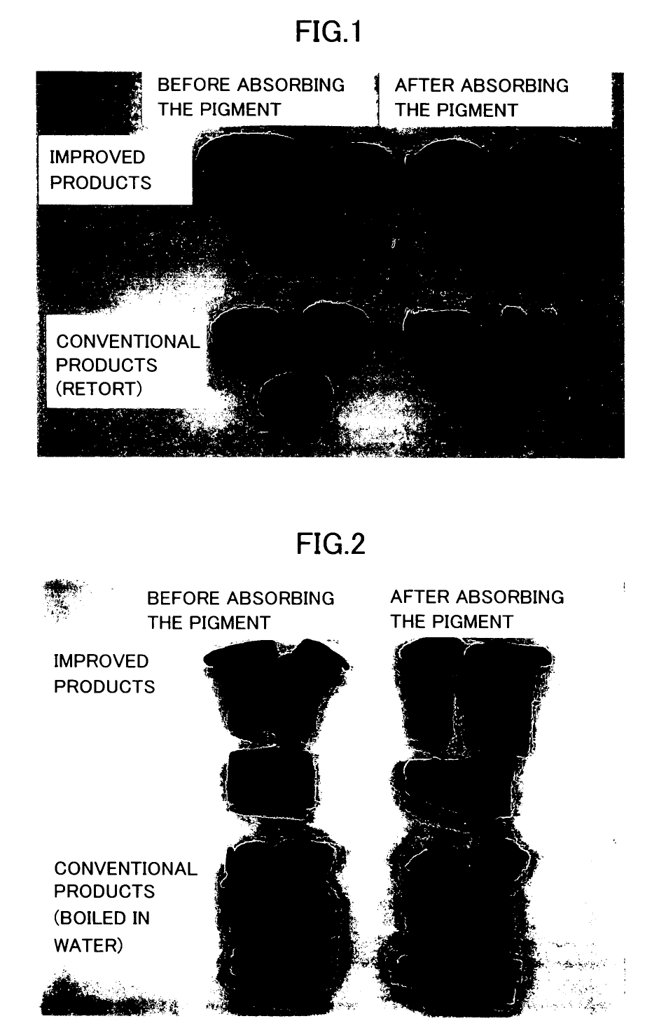

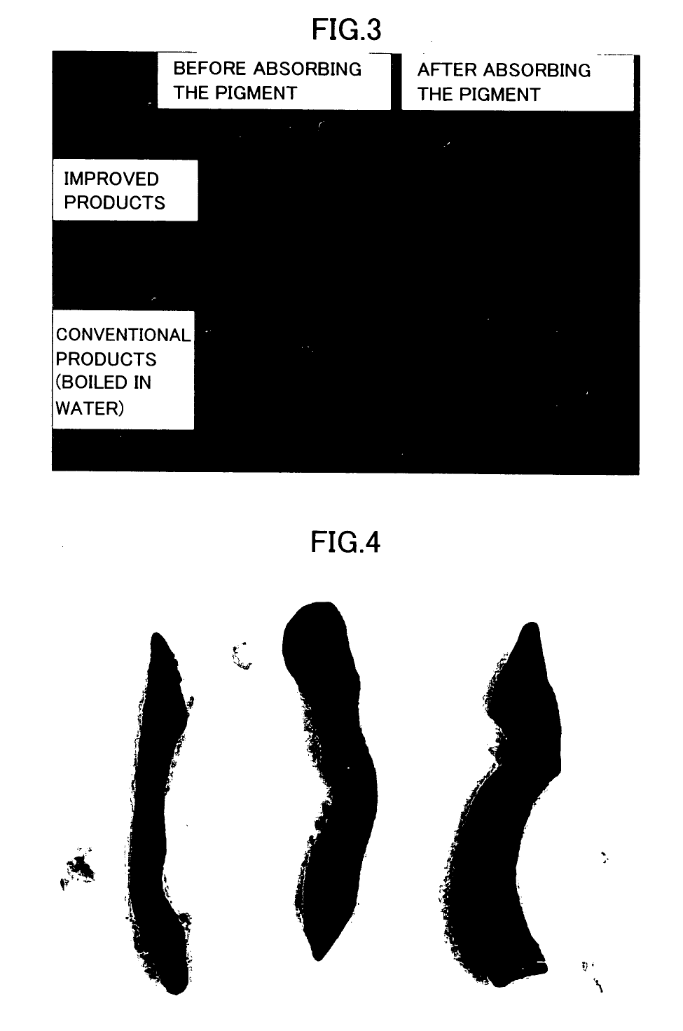

The photographs showing the results of the caramel staining test on mushrooms, Eringi mushrooms, and Hiratake mushrooms are shown in FIGS. 1, 2, and 3, respectively. FIG. 4 shows the enlarged photograph of the conventional products boiled in water in FIG. 3. In each figure, the upper column shows the frozen products while the lower column shows the products boiled in water, the left side shows the conditions thereof before staining, and the right side shows the conditions thereof after staining.

The parts which easily burst in general (determined from FIGS. 1 to 3) when the fungi were heated and cooked with the microwave oven were cut into the thickness of 5 mm and the area of 1 square cm from the above taken fungi. (The mushrooms and Eringi mushrooms were cut into 10×10×5 mm. The Hiratake mushrooms were cut into the thickness of 5 mm and adjusted to become 0.5 g in weight.)

In order to supplement water which was extruded by cutting, the fungi were immersed in water at normal temperature for 1 minute and the water thereof was lightly drained.

Next, after wrapping them with kimwipes, 0.5 (kgf/cm²) of pressure was put for 15 seconds on them and then their weights were determined before and after putting the pressure.

The dehydrated samples were immersed in water at normal temperature for 15 seconds and taken from the water. The surfaces thereof were roughly wiped and then their weights were determined. The results are collectively shown in Tables 1 to 3.

TABLE 1
(Mushrooms)

| | | | Weight | | |
|---|---|---|---|---|---|
| | Initial | Weight after | after | Dehy- | |
| | weight | dehydration | absorption | dration | Absorption |
| | (g) | (g) | (g) | rate (%) | rate (%) |
| Refrigeration | 0.50 | 0.30 | 0.47 | 40.0% | 34.0% |
| Boiling in | 0.51 | 0.43 | 0.44 | 15.7% | 2.0% |
| water | | | | | |

TABLE 2
(Eringi mushrooms)

| | | | Weight | | |
|---|---|---|---|---|---|
| | Initial | Weight after | after | Dehy- | |
| | weight | dehydration | absorption | dration | Absorption |
| | (g) | (g) | (g) | rate (%) | rate (%) |
| Refrigeration | 0.48 | 0.25 | 0.44 | 47.9% | 39.6% |
| Boiling in | 0.51 | 0.42 | 0.44 | 17.6% | 3.9% |
| water | | | | | |

TABLE 3
(Hiratake mushrooms)

| | | | Weight | | |
|---|---|---|---|---|---|
| | Initial | Weight after | after | Dehy- | |
| | weight | dehydration | absorption | dration | Absorption |
| | (g) | (g) | (g) | rate (%) | rate (%) |
| Refrigeration | 0.50 | 0.29 | 0.46 | 42.0% | 34.0% |
| Boiling in | 0.47 | 0.38 | 0.4 | 19.1% | 6.4% |
| water | | | | | |

Meanwhile, the fungi were taken from the retort pouch which was retort-sterilized as mentioned above and put into a dish. The sound of burst of the fungi was checked when being heated for 2 minutes by a 500 W microwave oven. The conditions of the fungi were also visually checked after being heated by the microwave oven. Table 4 collectively shows the results of the burst tests wherein each of the mushrooms, Eringi mushrooms and Hiratake mushrooms which were boiled in water or the refrigerated ones thereof were used. The fungi were judged as those having the performance of the present invention, in case of meeting the condition that they did not make the sound of burst in accordance with the above method.

TABLE 4-1
Mushrooms which were sliced into the thickness of 5 mm

| | Number of | Number of | Burst |
|---|---|---|---|
| | burst ones | non-burst ones | rate (%) |
| Conventional | 32 | 8 | 80.0% |
| products | | | |
| Improved products | 0 | 40 | 0.0% |

TABLE 4-2
Eringi mushrooms

| | Number of | Number of | Burst |
|---|---|---|---|
| | burst ones | non-burst ones | rate (%) |
| Conventional | 18 | 2 | 90.0% |
| products | | | |
| Improved products | 0 | 20 | 0.0% |

TABLE 4-3
Hiratake mushrooms

| | Number of | Number of | Burst |
|---|---|---|---|
| | burst ones | non-burst ones | rate (%) |
| Conventional | 16 | 4 | 80.0% |
| products | | | |
| Improved products | 0 | 20 | 0.0% |

What is claimed is:

1. A processed food for cooking by heating with a microwave oven, containing edible fungi which do not make the sound of burst at the time of cooking by heating with the microwave oven due to treatments after harvesting them.

2. A processed food for cooking by heating with a microwave oven, containing edible fungi wherein the water absorption ratio of parts corresponding to those that are lightly stained in the caramel staining test is 15 weight % or more.

3. The processed food according to claim 2, wherein the water absorption ratio of the parts that are lightly stained in the test is 20 weight % or more.

4. The processed food according to claim 1, wherein the fungi are at least one kind selected from the group consisting of mushrooms, Eringi mushrooms, Shimeji mushrooms and Hiratake mushrooms.

5. The processed food according to claim 1, wherein the fungi are selected from the group consisting of mushrooms, Eringi mushrooms and Hiratake mushrooms.

6. The processed food according to claim 1 which is a retort food.

7. A method for producing the processed food for cooking by heating with a microwave oven, which comprises steps of blanching fungi, if necessary, after harvesting them; and then freezing the fungi to use them as ingredients in the food.

8. A method for producing the processed food for cooking by heating with a microwave oven, which comprises steps of blanching fungi after harvesting them; and then freezing the fungi to use them as ingredients in the food.

9. The method according to claim 8, wherein the blanching is conducted in such that the fungi is immersed in hot water of 70 to 100° C. for 1 to 10 minutes.

10. The method according to claim 8, wherein the freezing is conducted in such that the fungi is frozen at −10° C. or lower.

11. The method according to claim 8, wherein the frozen fungi together with other ingredients and sauce are charged into a retort container and subjected to retort-sterilization at about 110 to 135° C. for 5 to 130 minutes.
